(19) United States
(12) Patent Application Publication
(10) Pub. No.: US 2007/0297445 A1
(43) Pub. Date: Dec. 27, 2007

(54) PROTOCOL TRANSLATING DEVICE AND METHOD

(75) Inventor: WEN-PIN LU, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/765,460

(22) Filed: Jun. 20, 2007

(30) Foreign Application Priority Data
Jun. 23, 2006 (TW) 95122724

(51) Int. Cl. H04J 3/16

(52) U.S. Cl. 370/466

(57) ABSTRACT

A protocol translating device (20) for protocols translating, includes a protocol parsing module (200), an endpoint management module (210), a call control state machine (220), and a protocol primitive module (230). The protocol parsing module is used for parsing notices, and sending call events corresponding to the notices. The endpoint management module is used for translating the call events to endpoint management call events. The call control state machine is used for receiving the endpoint management call events, retrieving corresponding call states, determining a type of endpoint management digit collected events, and sending a call make according to the corresponding call states and the type of the endpoint management digit collected events. The protocol primitive module is used for determining a type of the call make and sending a protocol call make request to a corresponding protocol sub-module according to the type of the call make.

### BACKGROUND OF THE INVENTION

1. Field of the Invention

The invention relates to protocol translating devices, and particularly to a protocol translating device supporting a plurality of network protocols.

2. Description of Related Art

With the development of network communication technologies, the voice over Internet protocol (VoIP) becomes more and more popular, and VoIP-related protocols, such as the session initiation protocol (SIP), the H.323 protocol, the media gateway control protocol (MGCP), etc, are developed and used by people. Each of the VOIP-related protocols corresponds to a specific application programming interface (API), and each API only supports the corresponding VoIP-related protocol.

When an VoIP device needs to add a new VoIP service, it must correspondingly add a new corresponding API to support the new VoIP service. Therefore hardware of the VoIP terminal device must be upgraded, which takes time and costs money.

### SUMMARY OF THE INVENTION

An exemplary embodiment of the invention provides a protocol translating device applied in a VoIP device for translating different protocols. The protocol translating device includes a protocol parsing module, an endpoint management module, a call control state machine, and a protocol primitive module. The protocol parsing module is used for parsing notices, and sending call events corresponding to the notices, the call events including an off-hook event and digit collected events. The endpoint management module is used for translating the call events to endpoint management call events including an endpoint management off-hook event and endpoint management digit collected events. The call control state machine is used for receiving the endpoint management call events, retrieving corresponding call states from the endpoint management call events including call states thereof, determining a type of the endpoint management digit collected events, and sending a call make according to the corresponding call states and the type of the endpoint management digit collected events. The protocol primitive module is used for determining a type of the call make sent from the call control state machine and sending a protocol call make request to a corresponding protocol sub-module according to the type of the call make.

Another exemplary embodiment of the invention provides a protocol translating method. The method includes receiving notices; sending call events corresponding to the notices, the call events including an off-hook event and digit collected events; translating the call events to endpoint management call events including an endpoint management off-hook event and endpoint management digit collected events; retrieving corresponding call states from the endpoint management call events, the endpoint management call events including call states thereof; determining a type of the endpoint management digit collected events; sending a call make according to the corresponding call states and the type of the endpoint management collected events; determining a type of the call make; and sending a protocol call make request to a corresponding protocol sub-module according to the type of the call make.

Other advantages and novel features will become more apparent from the following detailed description when taken in conjunction with the accompanying drawings, in which:

### BRIEF DESCRIPTION OF THE DRAWINGS

FIG. 1 is a block diagram of a protocol translating device of an exemplary embodiment of the invention;

FIG. 2 is a flowchart of a protocol translating method of an exemplary embodiment of the invention;

FIG. 3 is a flowchart of the protocol translating method of FIG. 2; and

FIG. 4 is a flowchart of a protocol translating method of a further exemplary embodiment of the invention.

### DETAILED DESCRIPTION OF THE INVENTION

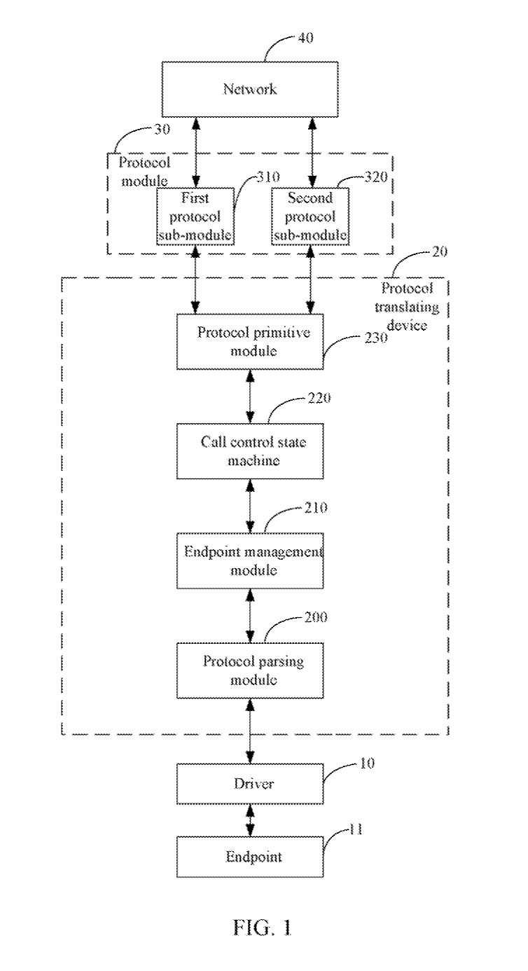

FIG. 1 is a block diagram of a protocol translating device 20 of an exemplary embodiment of the invention. In the exemplary embodiment, a driver 10 is connected to a network 40 via the protocol translating device 20 and a protocol module 30. In the exemplary embodiment, the driver 10 is used for sending a notice to the protocol translating device 20 when an endpoint 11 connected to the driver 10 detects a call event is generated, and the driver 10 may be a media gateway control protocol (MGCP) driver. In the exemplary embodiment, the call event may be an off-hook event and a dial-tone event, and the notice identifies the call event. The protocol module 30 includes a plurality of protocol sub-modules 310 and 320. In the exemplary embodiment, the first protocol sub-module 310 may be a session initiation protocol (SIP) sub-module 310, and the second protocol sub-module 320 may be an H.323 sub-module 320. In other exemplary embodiments, the driver 10 may be some other type of protocol driver, and the protocol module 30 may be or include other protocol modules.

The protocol translating device 20 is used for translating events of various protocols. In the exemplary embodiment, the protocol translating device 20 can translate call events into SIP events or H.323 events, or translate SIP events and H.323 events into call events.

In the exemplary embodiment, the protocol translating device 20 includes a protocol parsing module 200, an endpoint management module 210, a call control state machine 220, and a protocol primitive module 230. In the exemplary embodiment, the protocol parsing module 200 is connected to the driver 10 and the endpoint management module 210, and is used for parsing notices sent by the driver 10 and sending call events corresponding to the notices to the endpoint management module 210.

In the exemplary embodiment, the notices respectively represent call events, and the call events include an off-hook event and digit collected events sent in turn. Each digit collected event represents a digit being dialed.

In the exemplary embodiment, after the endpoint 11 detects an off-hook event, the driver 10 sends a notice to the protocol parsing module 200. After receiving the notice, the protocol parsing module 200 sends an acknowledgement (ACK) message to the driver 10, and parses the notice into the off-hook event. Then the protocol parsing module 200 sends the off-hook event to the endpoint management module 210.

After the endpoint 11 detects a dial-tone event, the driver 10 sends a notice to the protocol parsing module 200. After receiving the notice, the protocol parsing module 200 sends another ACK message to the driver 10, and parses the notice into a digit collected event. Then the protocol parsing module 200 sends the digit collected event to the endpoint management module 210.

The endpoint management module 210 is connected to the protocol parsing module 200 and the call control state machine 220, and is used for translating the call events to endpoint management call events including an endpoint management off-hook event and endpoint management digit collected events. When the endpoint management module 210 receives the off-hook event from the protocol parsing module 200, the endpoint management module 210 translates the off-hook event to the endpoint management off-hook event, and sends the endpoint management off-hook event to the call control state machine 220. When the endpoint management module 210 receives the digit collected events from the protocol parsing module 200, the endpoint management module 210 collects and translates the digit collected events into the endpoint management digit collected events, and sends the endpoint management digit collected events to the call control state machine 220 in turn.

The call control state machine 220 is connected to the endpoint management module 210 and the protocol primitive module 230, and is used for receiving the endpoint management call events from the endpoint management module 210, retrieving corresponding call states from the endpoint management call events including call states thereof, determining a type of the endpoint management digit collected events, and sending a call make according to the corresponding call states and the type of the endpoint management digit collected events. The call control state machine 220 determines the type of the endpoint management digit collected events by determining a type of a digit sequence formed via the endpoint management digit collected events. In the exemplary embodiment, the call states include an idle state, a dialing state, a digit collected state, and a call initiated state. In the exemplary embodiment, an original call state of the call control state machine 220 is the idle state. In the exemplary embodiment, the call control state machine 220 is further used for sending an endpoint management dial-tone request to the endpoint management module 210 to make the endpoint 11 dial via the protocol parsing module 200, if the call control state machine 220 receives the endpoint management off-hook event from the endpoint management module 210.

In the exemplary embodiment, after the call control state machine 220 receives the endpoint management digit collected event from the endpoint management module 210, the call control state machine 220 switches the dialing state to the digit collected state. After the dialing state is switched to the digit collected state, the call control state machine 220 receives the endpoint management digit collected events from the endpoint management module 210 in turn, and forms the digit sequence after receiving all the endpoint management digit collected events. In the exemplary embodiment, the types of the digit sequence include a first protocol type and a second protocol type. In the exemplary embodiment, the first protocol type is an SIP type supported by the first protocol sub-module 310, and the second protocol type is an H.323 type supported by the second protocol sub-module 320. In the exemplary embodiment, the call control state machine 220 determines the type of the digit sequence by comparing the digit sequence with a digit map including an SIP digit map supported by the SIP protocol and a H.323 digit map supported by the H.323 protocol. In the exemplary embodiment, if the digit sequence matches the SIP digit map, the call control state machine 220 switches the digit collected state to the call initiated state, and sends an SIP protocol call make to the protocol primitive module 230. If the digit sequence matches the H.323 digit map, the call control state machine 220 switches the digit collected state to the call initiated state, and sends an H.323 protocol call make to the protocol primitive module 230.

In the exemplary embodiment, if the endpoint management module 210 receives the endpoint management dial-tone request, the endpoint management module 210 translates the endpoint management dial-tone request into a dial-tone request, and sends the dial-tone request to the protocol parsing module 200. In the exemplary embodiment, the protocol parsing module 200 is further used for translating a plurality of requests from the endpoint management module 210 to a corresponding command. In the exemplary embodiment, the plurality of requests include a dial-tone request and a ringing request, if the protocol parsing module 200 receives the dial-tone request, the protocol parsing module 200 switches the dial-tone request to a dial-tone command, and sends the dial-tone command to the driver 10.

The protocol primitive module 230 is connected to the call control state machine 220 and the protocol module 30, and is used for determining a type of the call make sent from the call control state machine 220, and for sending a protocol call make request to a corresponding protocol sub-module according to the type of the call make. In the exemplary embodiment, the protocol primitive module 220 determines the type of the call make by parsing an address message. In the exemplary embodiment, the address message includes a destination address message. If the type of the call make is the first protocol type, the protocol primitive module 230 sends a first protocol call make request to the first protocol sub-module 310. The first protocol sub-module 310 sends a first protocol setup message to the network 40 for establishing connection between the endpoint 11 and the network 40. In the exemplary embodiment, the first protocol setup message is an SIP invite message. If the type of the call make is a second protocol type, the protocol primitive module 230 sends a second protocol call make request to the second protocol sub-module 320. The second protocol sub-module 320 sends a second setup message to the network 40 for establishing connection between the endpoint 11 and the network 40. In the exemplary embodiment, the second setup message is an H.323 setup message.

In the exemplary embodiment, the protocol primitive module 230 is further used for receiving a received call make message from the protocol module 30, and recording an address message of the received call make message. In the exemplary embodiment, the address message includes a source address message. In the exemplary embodiment, if the protocol primitive module 230 records the received address message of the received call make message, the protocol primitive module 230 sends a call message to the call control state machine 220. The call control state machine 220 is further used for receiving a message from the protocol primitive module 230 and recording the corresponding call state, and doing a corresponding action according to the corresponding call state.

In the exemplary embodiment, the original call state of the call control state machine 220 is an idle state, if the call control state machine 220 receives the call message, the call control state machine 220 switches the idle state to the ringing state, sends a call accept message to the protocol primitive module 230 to send to the network 40, and sends an endpoint management ringing request to the endpoint management module 210. The endpoint management module 210 receives the endpoint management ringing request from the call control state machine 220, then the endpoint management module 210 sends a ringing request to the protocol parsing module 200. The protocol parsing module 200 receives the ringing request from the endpoint management module 210, translates the ringing request to a connecting command, and sends to the driver 10 for connecting between the endpoint 11 and the network 40.

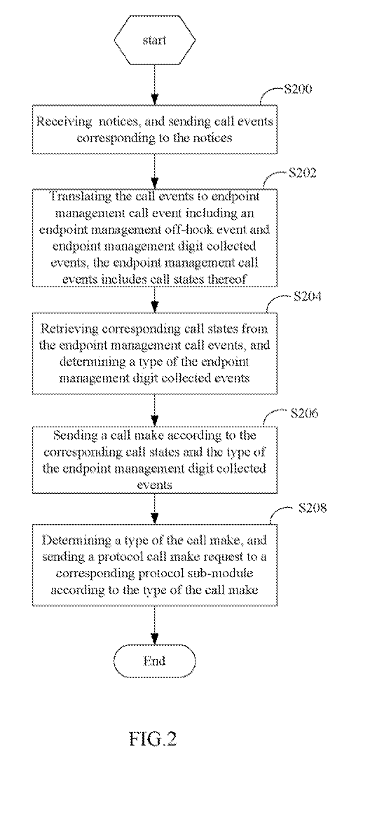

FIG. 2 is a flowchart of a protocol translating method of an exemplary embodiment of the invention. In step S200, the protocol parsing module 200 receives notices, and sending call events corresponding to the notices to the endpoint management module 210. In the exemplary embodiment, the call events include an off-hook event and digit collected events. When the protocol parsing module 200 parses a notice into the off-hook event, the protocol parsing module 200 sends the off-hook event to the endpoint management module 210. When the protocol parsing module 200 parses a notice into a first digit collected event, the protocol module 200 sends the first digit collected event to the endpoint management module 210.

In step S202, the endpoint management module 210 translates the call events to endpoint management call events including an endpoint management off-hook event and endpoint management digit collected events, the endpoint management call events includes call states thereof. In the exemplary embodiment, after the endpoint management module 210 receives the off-hook event, the endpoint management module 210 translates the off-hook event to the endpoint management off-hook event, and sends the endpoint management off-hook event to the call control state machine 220. After the endpoint management module 210 receives the first digit collected event, the endpoint management module 210 translates the first digit collected event to a first endpoint management digit collected event, and sends the first endpoint management digit collected event to the call control state machine 220 until having collected all the digit collected events.

In step S204, the call control state machine 220 retrieves corresponding call states from the endpoint management call events, and determines a type of the endpoint management digit collected events. In the exemplary embodiment, after the call control state machine 220 receives the endpoint management off-hook event, the call control state machine 220 switches an idle state to a dialing state, and sends an endpoint management dial-tone request to the endpoint management module 210. After the call control state machine 220 receives the first endpoint management digit collected event, the call control state machine 220 switches the dialing state to a digit collected state, and forms a digit sequence after collecting all the endpoint management digit collected events. In the exemplary embodiment, the call control state machine 220 determines the type of the endpoint management digit collected events by determining the type of the digit sequence.

In step S206, the call control state machine 220 sends a call make according to the corresponding call states and the type of the endpoint management digit collected events. In the exemplary embodiment, the call control state machine 220 sends a first protocol type call make to the protocol primitive module 230 after switching the digit collected state to a call initiated state, if the type of the digit sequence is a first protocol type. The call control state machine 220 sends a second protocol type call make to the protocol primitive module 230 after switching the digit collected state to a call initiated state, if the type of the digit sequence is a second protocol type.

In step S208, the protocol primitive module 230 determines a type of the call make, and sends a protocol call make request to a corresponding protocol sub-module according to the type of the call make.

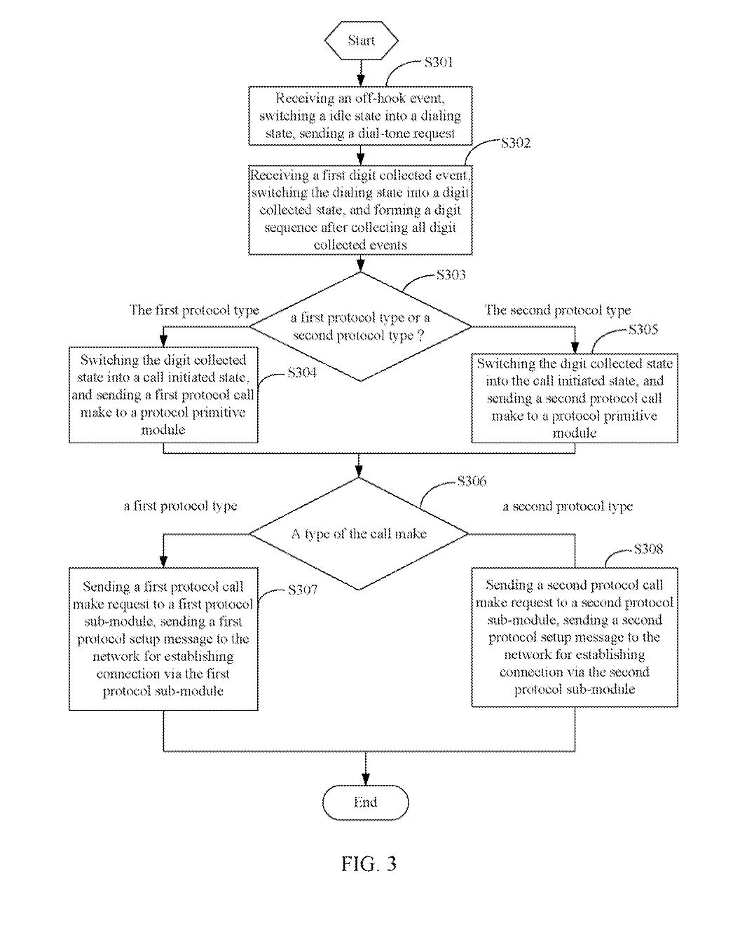

FIG. 3 is a flowchart of the protocol translating method of FIG. 2 in detail. In step S301, the protocol translating device 20 receives an off-hook event, switches an idle state in a dialing state, and sends a dial-tone request. In the exemplary embodiment, when an endpoint 11 detects that an off-hook event happens, the driver 10 sends a notice to the protocol parsing module 200. Then the protocol parsing module 200 sends an acknowledgement (ACK) message to the driver 10, parses the notice into an off-hook event, and transmits the off-hook event to the endpoint management module 210. The endpoint management module 210 receives the off-hook event, translates the off-hook event to an endpoint management off-hook event, and sends the endpoint management off-hook event to the call control state machine 220. An original call state of the call control state machine 220 is an idle state, after the call control state machine 220 receives the endpoint management off-hook event from the endpoint management module 210, the call control state machine 220 switches the idle state to a dialing state, and sends an endpoint management dial-tone request to the endpoint management module 210. After the endpoint management module 210 receives the endpoint management dial-tone request from the call control state machine 220, the endpoint management module 210 translates the endpoint management dial-tone request to a dial-tone request, and sends the dial-tone request to the protocol parsing module 200. After the protocol parsing module 200 receives the dial-tone request, then the protocol parsing module 200 translates the dial-tone request to a dialing command, and sends the dialing command to the driver 10 to make the endpoint 11 dial number.

In step S302, the protocol translating device 20 receives a first digit collected event, switches the dialing state to a digit collected state, and forms a digit sequence after collecting all the digit collected events. In the exemplary embodiment, after the endpoint 11 detects that a dialing event happens, the driver 10 sends a notice representing a digit collected event to the protocol parsing module 200. After the protocol parsing module 200 sends an ACK message to the driver 10, the protocol parsing module 200 parses the notice into a digit collected event, and sends a first digit collected event to the endpoint management module 210. After the endpoint management module 210 receives the first digit collected event from the protocol parsing module 200, the endpoint management module 210 knows the endpoint 11 is in the dialing state, and starts to collect the digit collected events. After the endpoint management module 210 has collected all the digit collected events, the endpoint management module 210 sends a first endpoint management digit collected event to the call control state machine 220. After the call control state machine 220 receives the first endpoint management digit collected event from the endpoint management module 210, the call control state machine 220 switches the dialing state to a digit collected state, and forms a digit sequence after receiving all the endpoint management digit collected events.

In step S303, the call control state machine 220 determines a type of the digit sequence. In the exemplary embodiment, the types of the digit sequence include a first protocol type and a second protocol type. In the exemplary embodiment, the first protocol type may be a session initiation protocol (SIP) type supported by the first protocol sub-module 310, the second protocol type may be an H.323 type supported by the second protocol sub-module 320. In the exemplary embodiment, the call control state machine 220 determines the type of the digit sequence by comparing the digit sequence with a digit map including a SIP digit map supported by the SIP protocol and a H.323 digit map supported by the H.323 protocol.

In step S304, if the digit sequence matches the SIP digit map, that is, the digit sequence type is the first protocol type, the call control state machine 220 switches the digit colleted state to the call initiated state, and sends a first protocol type call make including a call make address to the protocol primitive module 230.

In step S305, if the digit sequence matches the H.323 type, that is, the digit sequence is the second protocol type, the call control state machine 220 switches the digit collected state to the call initiated state, and sends a second protocol type call make including an address message to the protocol primitive module 230.

In step S306, the protocol primitive module 230 determines a type of the call make. In the exemplary embodiment, the protocol primitive module 230 determines the type of the call make by parsing the address message.

In step S307, if the type of the call make is the first protocol type, the protocol primitive module 230 sends a first protocol type call make request to the first protocol sub-module 310, and the first protocol sub-module 310 sends a first protocol setup message to the network 40 for establishing connection. The first protocol setup message is an SIP invite message.

In step S308, if the type of the call make is the second protocol type, the protocol primitive module 230 sends a second protocol type call make request to the second protocol sub-module 320, and the second module 320 sends a second protocol setup message to the network 40 for establishing connection. In the exemplary embodiment, the second protocol setup message is a H.323 setup message.

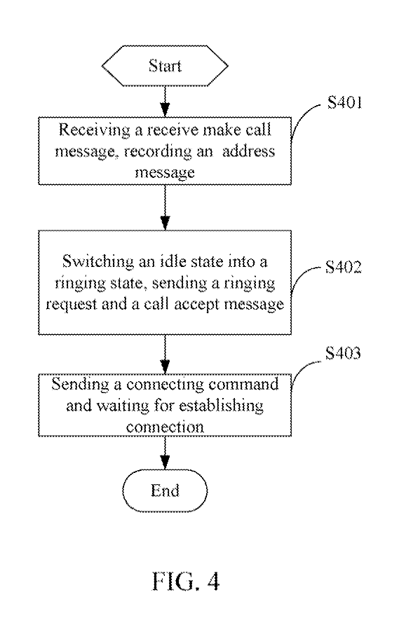

FIG. 4 is a flowchart of a protocols translating method of a further exemplary embodiment of the invention. In step S401, the protocol translating device 20 receives a received call make message, records an address message thereof, and sends a call message to the call control state machine 220. In another exemplary embodiment, the address message includes a source address message, the source address message identifies a type of the call message, and the types include a first type and a second type. The first type is an SIP type, the second type is a H.323 type.

In step S402, the call control state machine 220 switches the idle state to a ringing state, sends an endpoint management ringing request to the endpoint management module 210, and sends a call accept message to the protocol primitive module 230. In the exemplary embodiment, when the call control state machine 220 is in the idle state, if the call control state machine 220 receives the call message, the call control state machine 220 sends a call accept message to the protocol module 30 via the protocol primitive module 230, and sends the endpoint management ringing request to the endpoint management module 210.

In step S403, the protocol translating device 20 sends a connecting command to the endpoint for establishing connection. In another exemplary embodiment, when receiving the endpoint management ringing request from the call control state machine 220, the endpoint management module 210 sends a ringing request to the protocol parsing module 200. Subsequently, the protocol parsing module 200 translates the ringing request into a connecting command, and sends the connecting command to the driver 10 for establishing connection between the endpoint 11 and the network 40.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A protocol translating device applied in a VoIP device for translating different protocols, the protocol translating device comprising:
a protocol parsing module, for parsing notices, and sending call events corresponding to the notices, the call events comprising an off-hook event and digit collected events;
an endpoint management module for translating the call events to endpoint management call events comprising an endpoint management off-hook event and endpoint management digit collected events;
a call control state machine for receiving the endpoint management call events, retrieving corresponding call states from the endpoint management call events comprising call states thereof, determining a type of the endpoint management digit collected events, and sending a call make according to the corresponding call states and the type of the endpoint management digit collected events; and
a protocol primitive module for determining a type of the call make sent from the call control state machine and sending a protocol call make request to a corresponding protocol sub-module according to the type of the call make.

2. The protocol translating device of claim 1, wherein the call control state machine is further used for receiving the endpoint management off-hook event, switching an idle state to a dialing state, and sending an endpoint management dial-tone request to the endpoint management module to make an endpoint dial via the protocol parsing module in the dialing state.

3. The protocol translating device of claim 2, wherein the endpoint management module is further used for receiving and collecting digit collected events from the protocol parsing module, and translating the digit collected events to the endpoint management digit collected events, and sending the endpoint management digit collected events to the call control state machine in turn.

4. The protocol translating device of claim 3, wherein the call control state machine is further used for receiving the endpoint management digit collected events from the endpoint management module, switching the dialing state into a digit collected state, and forming a digit sequence after receiving all the endpoint management digit collected events.

5. The protocol translating device of claim 4, wherein the call control state machine is further used for determining the type of the endpoint management digit collected events by determining a type of the digit sequence, and determining the type of the digit sequence by comparing the digit sequence with a digit map comprising different protocol digit map.

6. The protocol translating device of claim 5, wherein the call control state machine is further used for switching the digit collected state into a call initiated state, and sending a corresponding protocol type call make to the protocol primitive module according to the type of the call events in the call initiated state.

7. The protocol translating device of claim 6, wherein the protocol types comprise an SIP type and an H.323 type.

8. The protocol translating device of claim 6, wherein the protocol primitive module is further used for determining the type of the call make sent from the call control state machine by parsing an address message of the call make.

9. The protocol translating device of claim 8, wherein the protocol primitive module is further used for sending a call make request to a corresponding protocol sub-module.

10. A protocol translating method, comprising steps of:
receiving notices;
sending call events corresponding to the notices, the call events comprising an off-hook event and digit collected events;
translating the call events to endpoint management call events comprising an endpoint management off-hook event and endpoint management digit collected events, the endpoint management call events comprising call states thereof;
retrieving corresponding call states from the endpoint management call events;
determining a type of the endpoint management digit collected events;
sending a call make according to the corresponding call states and the type of the endpoint management digit collected events;
determining a type of the call make; and
sending a protocol call make request to a corresponding protocol sub-module according to the type of the call make.

11. The protocol translating method of claim 10, wherein the step of sending call events corresponding to the notices, the call events comprising an off-hook event and digit collected events comprises:
parsing the notice for an off-hook event, and sending the off-hook event to an endpoint management module; and
parsing the notice for an first digit collected event, and sending the first digit collected event to the endpoint management module.

12. The protocol translating method of claim 11, wherein the step of translating the call events to endpoint management call events comprising an endpoint management off-hook event and endpoint management digit collected events, the endpoint management call events comprising call states thereof comprises:
receiving the off-hook event;
translating the off-hook event to the endpoint management off-hook event; and
sending the endpoint management off-hook event to a call control state machine.

13. The protocol translating method of claim 12, wherein the step of retrieving corresponding call states from the endpoint management call events comprises:
receiving the endpoint management off-hook event;
switching an idle state into a dialing state; and
sending an endpoint management dial-tone request to the endpoint management module.

14. The protocol translating method of claim 13, wherein the step of translating the call events to endpoint management call events comprises comprising an endpoint management off-hook event and endpoint management digit collected events, the endpoint management call events comprising call states thereof:
receiving the first digit collected event;
translating the first digit collected event to an first endpoint management digit collected event; and
sending the first endpoint management digit collected event to the call control state machine until having collected all the digit collected events.

15. The protocol translating method of claim 14, wherein the step of retrieving corresponding call states from the endpoint management call events comprises:
receiving the first endpoint management digit collected event;
switching the dialing state into a digit collected state; and
forming a digit sequence after collecting all the endpoint management digit collected events.

16. The protocol translating method of claim 15, wherein the step of determining a type of the endpoint management digit collected events comprises determining the type of the endpoint management digit collected events by determining the type of the digit sequence.

17. The protocol translating method of claim 15, wherein the step of sending a call make according to the corresponding call states and the type of the endpoint management call events comprises:
sending a first protocol type call make to a protocol primitive module after switching the digit collected state to a call initiated state, if the type of the digit sequence is a first protocol type; and
sending a second protocol type call make to the protocol primitive module after switching the digit collected state to a call initiated state, if the type of the digit sequence is a second protocol type.

18. The protocol translating method of claim 17, wherein the step of determining a type of the call make comprises determining the type of the call make by parsing the address message thereof.

19. A method for translating different protocols to make and receive voice over Internet protocol (VoIP) calls, comprising steps of:
receiving notices related to one of making and receiving VoIP calls;
parsing said notices;
retrieving a type of said VoIP calls according to said parsed notices;
sending a protocol request to a corresponding protocol sub-module according to said type of said VoIP calls; and
establishing said VoIP calls based on protocols responsive to said protocol request from said corresponding protocol sub-module.

20. The method of claim 19, wherein said notices are parsed to be one of an off-hook event and digit collected events when said VoIP calls are intended to make, and are a received call make message when said VoIP calls are intended to receive.
